(19) United States
(12) Patent Application Publication
(10) Pub. No.: US 2025/0021926 A1
(43) Pub. Date: Jan. 16, 2025

(54) PROJECT MANAGEMENT USING GPS AND RFID

(71) Applicant: Saudi Arabian Oil Company, Dhahran (SA)

(72) Inventors: Dhafer Ali AlGarni, Dammam (SA); Tumadhir Abdulrazaq AlSharhan, Dhahran (SA); Dina Ibrahim AlAmer, Dhahran (SA)

(21) Appl. No.: 18/350,438

(22) Filed: Jul. 11, 2023

(51) Int. Cl. G06Q 10/0833; G06K 19/077

(52) U.S. Cl. CPC G06Q 10/0833; G06K 19/07758; G06Q 50/08

(57) ABSTRACT

This disclosure describes methods and systems for providing a fully integrated project management solution for construction projects. A method involves generating an 8D GPS-enabled building information model (BIM) including a plurality of materials of a project, where the 8D BIM includes respective planned GPS coordinates for the plurality of materials; obtaining respective identifying information for the plurality of materials, where the respective identifying information includes at least one of respective material numbers or respective purchase order numbers, and where respective RFID tags are attached to the plurality of materials; reading, using a GPS-enabled RFID reader at the worksite, a first RFID tag of a first material delivered to the worksite; responsively determining that the first material has been delivered to the worksite; and determining, by comparing actual GPS coordinates of the first material to the respective planned GPS coordinates of the first material, that the material has been correctly installed.

### TECHNICAL FIELD

This description relates to systems and methods for project management using GPS and RFID technology.

### BACKGROUND

Large energy companies manage a significant portfolio of engineering, procurement, and construction (EPC) capital projects for building and maintaining energy facilities (e.g., oil and gas production facilities). These projects are complex and require substantial resources to manage them. One area of particular complexity is managing project scope, progress measurement, and invoicing of procurement and construction activities during a project lifecycle.

### SUMMARY

Managing the scope, schedule, and progress for complex construction projects in a systematic, standardized, and integrated manner is challenging. For example, this type of management requires addressing different types of works conducted for different types of projects, such as onshore, offshore, downstream, and upstream projects. Additionally, many of the required management activities are time consuming, require traveling to sites, are error-prone, and lack accuracy. Moreover, existing solutions for capturing as-built models from worksites to compare with as-planned models are either costly, such as laser scanning, or do not provide the required accuracy for the comparison, such as image processing.

This disclosure provides a fully integrated project controls solution for construction projects (and other similar projects). In particular, this disclosure describes a project management system that uses eight-dimensional (8D) engineering drawings, GPS-enabled Radio Frequency Identification (RFID) reader(s), and event timestamps to accurately track procurement and construction progress during a project lifecycle. Based on the project tracking, the project management system can provide periodic progress reports, invoice verification for owner-operators, and invoice generation for contractors. Additionally, the project management system can generate an accurate 8D as-built model for construction progress verification and reporting.

More specifically, this disclosure describes systems and methods for tracking the delivery of procured materials (e.g., equipment, pipe, instrument, cable, etc.) and the physical installation of the delivered materials to link them with an overall project progress. The disclosed systems and methods reduce or eliminate the effort of physically visiting sites to confirm the delivery and installation of materials and equipment at project sites. In some implementations, a project management system uses RFID technology to track the delivery and physical installation of a material. This allows the system to automatically complete the procurement and construction status for the material. Specifically, the project management system facilitates for an active RFID tag to be attached to the material.

Once the material is delivered to a site, the system uses an RFID reader integrated with GPS to determine that the material has been delivered to the site. Additionally, the system can use actual GPS coordinates (x-axis, y-axis, and z-axis) of the material at the site to determine an installation status of the material. Specifically, the system can compare the actual GPS coordinates with the planned GPS coordinates—found in an 8D building information model (BIM)—in order to determine the installation status of the material. Moreover, the system can capture a timestamp of the actual installation time and date to update a project schedule with actual dates, forecast the completion date more accurately, report periodic progress to interested parties, manage the risk of delays in material installation for activities on a critical path, and generate periodic invoices from vendors to owner-operators or verify periodic invoices from vendors to owner-operators.

One aspect of the subject matter described in this specification may be embodied in a method that involves generating an eight-dimensional (8D) GPS-enabled building information model (BIM) includes a plurality of materials of a project to be installed in a worksite, where the 8D BIM includes respective planned global positioning system (GPS) coordinates for the plurality of materials; obtaining respective identifying information for the plurality of materials, where the respective identifying information includes at least one of respective material numbers or respective purchase order numbers, and where respective radio frequency identification (RFID) tags are attached to the plurality of materials; reading, using a GPS-enabled RFID reader at the worksite, a first RFID tag of a first material delivered to the worksite, where the first RFID tag includes a first material ID of the first material and a purchase order ID of the first material; responsively determining that the first material has been delivered to the worksite; and determining, by comparing actual GPS coordinates of the first material to the respective planned GPS coordinates of the first material, that the material has been correctly installed in the worksite. The actual GPS coordinates are determined using the GPS-enabled RFID reader.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the method further involves printing the respective RFID tags for the plurality of materials; and attaching the respective RFID tags to the plurality of materials. For example, the project management system can provide instructions to a printing system to print the respective RFID tags.

In some implementations, the RFID reader is integrated with a GPS device.

In some implementations, responsively determining that the first material has been delivered to the worksite further involves updating a procurement status for the first material to indicate that that first material has been delivered.

In some implementations, the method further involves in response to updating the procurement status for the first material to indicate that that first material has been delivered, generating an invoice or verifying a vendor invoice for the first material.

In some implementations, responsively determining that the first material has been delivered to the worksite further involves generating a timestamp at a time of delivery; and updating, based on the timestamp, a completion time for the project.

In some implementations, the method further involves using the timestamp for at least one of: periodic progress reporting that is indicative of a number of procurement activities that have been completed within a time period; or verifying periodic invoices for work that has been completed within a contractual time period. Depending on the contractual agreement, the invoices can be submitted on a monthly basis for the work performed during the month, on a quarterly basis, or based on milestone completion. The time stamp will help verify the periodic invoices based on contractual agreements with the vendors.

In some implementations, the method further involves generating an 8D model of the project.

In some implementations, the method further involves updating the 8D model of the project based on the actual GPS coordinates of the first material.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1A illustrates a block diagram of an example project management system, according to some implementations.

FIG. 1B illustrates a block diagram of an example workflow for generating an eight-dimensional (8D) engineering drawing, according to some implementations.

FIG. 2 illustrates a block diagram of example data processed by a project management system, according to some implementations.

FIG. 3 illustrates a flowchart of an example method, according to some implementations.

FIG. 4 is a block diagram of an example computer system, according to some implementations.

### DETAILED DESCRIPTION

The disclosure provides a fully integrated project controls solution for construction projects (and other similar projects). In particular, this disclosure describes a project management system that uses eight-dimensional (8D) engineering drawings (also called “as-planned drawings”), GPS-enabled Radio Frequency Identification (RFID) reader(s), and event timestamps to accurately track procurement and construction progress during a project lifecycle. Based on the project tracking, the project management system can provide periodic progress reports, invoice verification for owner-operators, and invoice generation for contractors. Additionally, the project management system can generate an accurate 8D as-built model for construction progress verification and reporting. The project management system can compare the 8D as-built model to the 8D as-planned engineering drawings for construction progress verification.

Large energy companies manage a significant portfolio of engineering, procurement, and construction capital projects for building and maintaining energy facilities (e.g., oil and gas production facilities). These projects are complex and require substantial resources to manage them. One area of complexity is managing project scope, progress measurement, and invoicing of procurement and construction activities during a project lifecycle. Managing the scope, schedule, and progress for complex construction projects in a systematic, standardized, and integrated manner is challenging. For example, this type of management requires addressing different types of tasks conducted for different types of projects, such as onshore, offshore, downstream, and upstream projects. Additionally, many of the required management activities are time consuming, require traveling to sites, are error-prone, consume significant resources (e.g., computing resources), and lack accuracy. Moreover, existing solutions for capturing as-built models from worksites to compare with as-planned models are either costly, such as laser scanning, or do not provide the required accuracy for the comparison, such as image processing.

As described in more detail below, the project management system generates an 8D as-planned model in a planning phase of a project. To do so, the project management system generates a 3D engineering model of the project, which serves as the basis for the 8D as-planned model. Among other things, the 3D engineering model includes schematics of the project that specify the materials needed for the project. The project management system then generates a project schedule that includes scheduled constructions activities for performing the project, which the project management system incorporates into the as-planned model. Then, the project management system performs a material take-off (MTO), which generates a list of required materials that need to be procured for the project. In particular, the MTO determines material identifiers (IDs) for the list of required materials, which the project management system also incorporates into the as-planned model.

The project management system then cost loads the project schedule, for example, by obtaining the material prices from the corporate master library and calculating the average man hours estimated to complete each task. The project management system also incorporates this information into the as-planned model. The project management system provides instructions to a procurement system to placing purchase orders for the materials. The procurement system provides the project management system with a purchase order number for each scheduled activity and/or for each material. Then, the project management system incorporates GPS coordinates into the as-planned model. The project management system does so by placing the engineering drawing of the project on a map to generate the expected GPS coordinates for each equipment, pipe, cable or instrument in the model.

Once the planning phase is complete, the project management system tracks the delivery of procured materials (e.g., equipment, pipes, cables, instruments, etc.) and the physical installation of the delivered materials to link them with an overall project progress. The project management system reduces or eliminates the effort of physically visiting sites to confirm the delivery and installation of materials and equipment at project sites. In some examples, the project management system uses RFID technology to track the delivery and physical installation of materials. This allows the system to automatically complete the procurement and construction status for the materials.

In order to track a material, the project management system facilitates for an active RFID tag to be attached to the material. Once the material is delivered to a site, the system uses a GPS-enabled RFID reader to determine that the material has been delivered to the site. Additionally, the project management system can use actual GPS coordinates (x-axis, y-axis, and z-axis) of the material at the site to determine an installation status of the material. Specifically, the project management system can compare the actual GPS coordinates with the planned GPS coordinates—found in 8D as-planned engineering drawings—to determine the installation status of the material. Moreover, the project management system can capture a timestamp of the actual installation time and date to update a project schedule with actual dates, forecast the completion date more accurately, report periodic progress to interested parties, manage the risk of delays in material installation for activities on a critical path, and/or generate or verify periodic invoices from EPC contractors to owner operators.

Additionally, the project management system will help owner-operators during operations and maintenance phase since the as-built model that will be handed over from project to operations upon the project closeout will contain the material ID and purchase order number per equipment, pipe, instrument, cable, etc. This will help enterprises during maintenance activities to retrieve accurate required information in a timely manner. The material ID will provide help getting the material specs from the corporate mater data library and the different vendors that can provide this material. The purchase order number will help enterprises determine the original vendor/manufacturer, the price, and other important details.

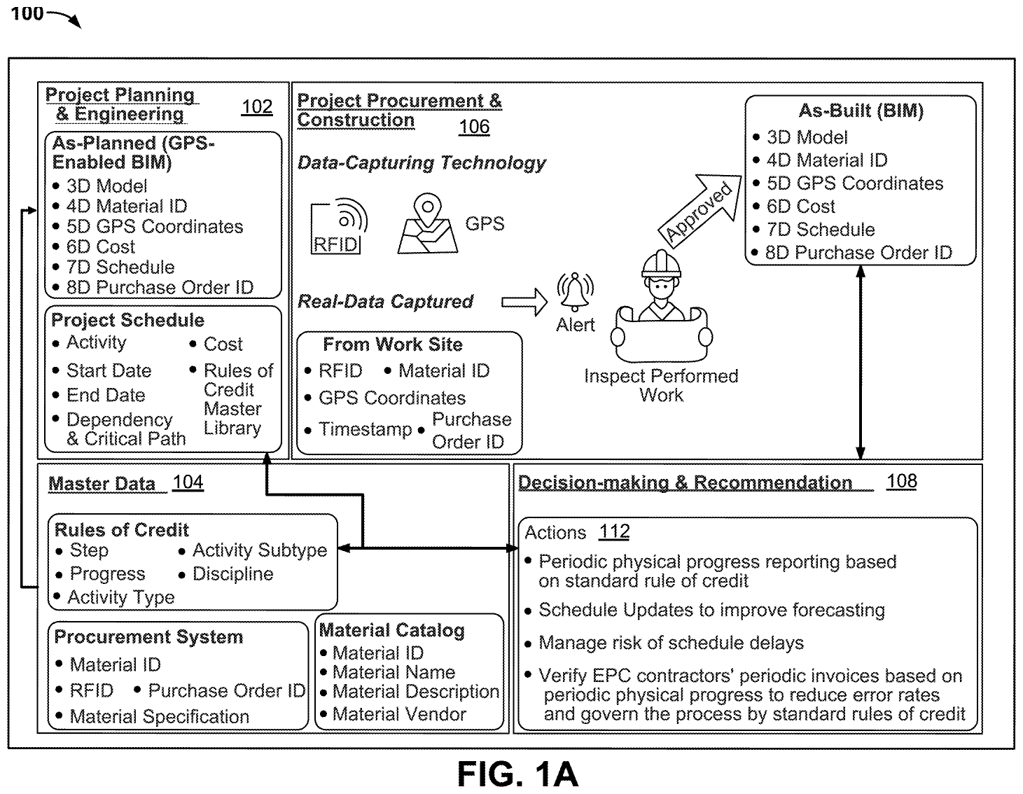

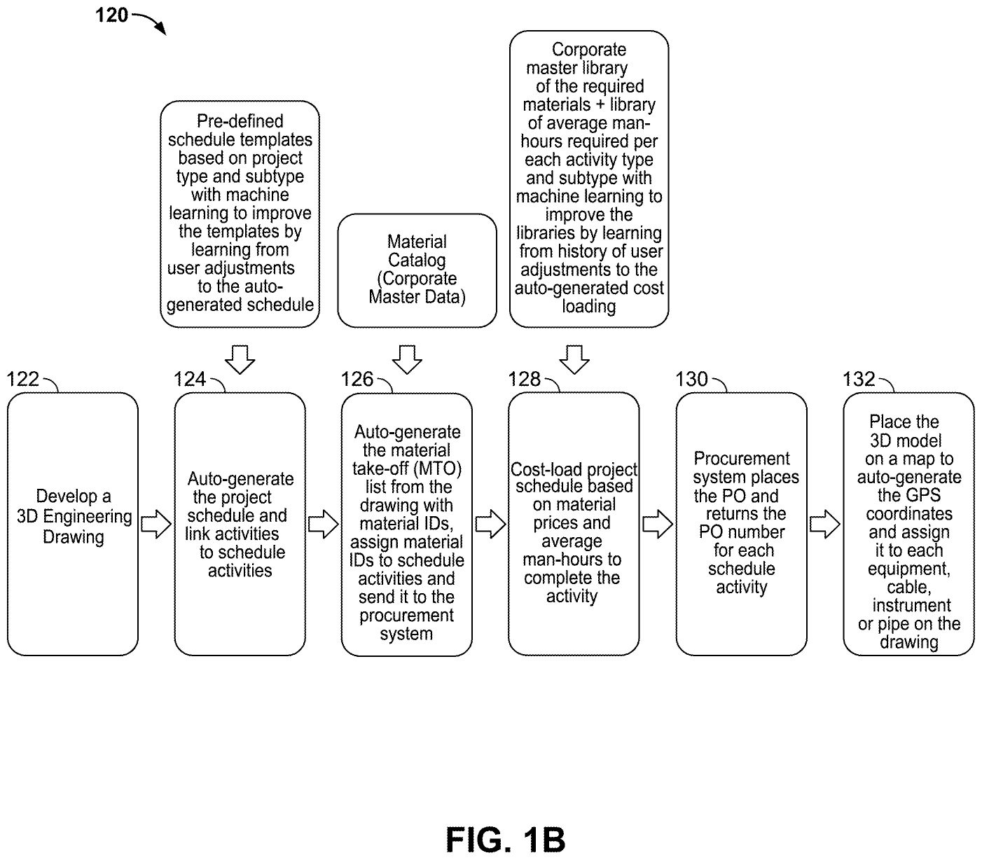

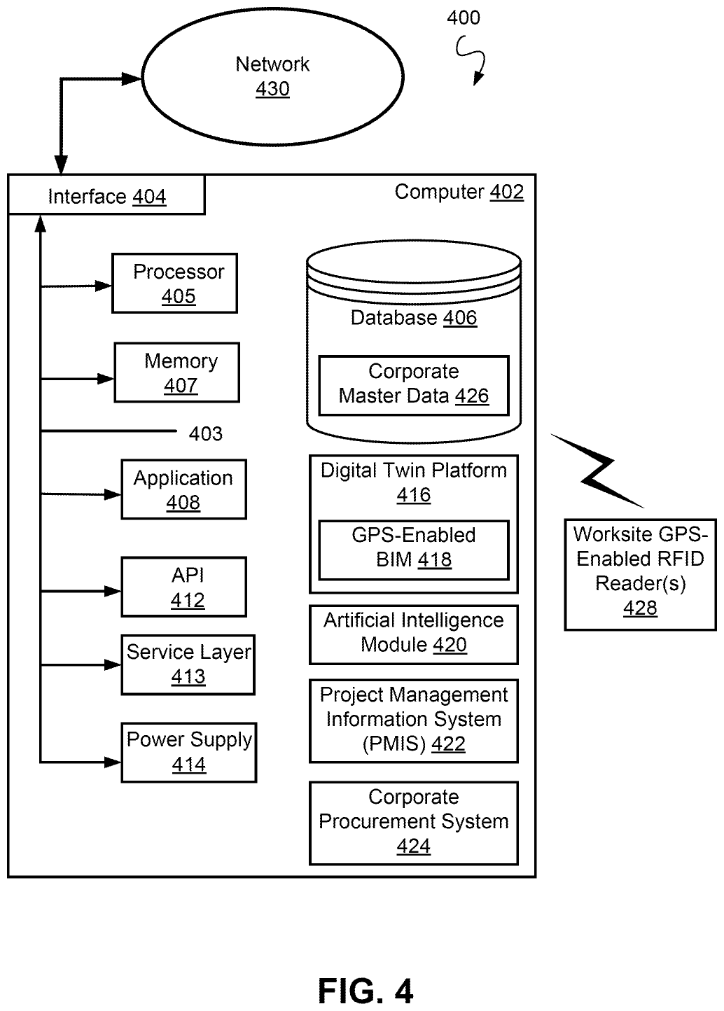

FIG. 1A illustrates a block diagram of an example project management system 100, according to some implementations. As shown in FIG. 1A, the project management system 100 includes a project planning and engineering module 102 (project planning module 102), a master data module 104, a project procurement and construction module 106, and a decision-making and recommendation module 108. The project management system 100 can be implemented using a computer system, such as the computer system 400 of FIG. 4. Note that the project management system 100 is shown for illustration purposes only, as the project management system 100 can include additional components or have one or more components removed without departing from the scope of the disclosure. Further, note that the various components of the project management system 100 can be arranged or connected in any manner.

In some implementations, the project management system 100 is configured to manage capital project engineering, procurement, and construction throughout a project lifecycle. The project management system 100 tracks activities and project steps at a granular level. Specifically, the project management system 100 tracks each activity or step based on a type of the activity or step, where each type has its own standard for work completion and calculating progress. The progress calculation can be based on engineering, procurement, and/or construction activities. The project management system 100 tracks the delivery of procured material (e.g., equipment, pipe, instrument, cable, etc.) and the physical installation of the delivered material to link them with an overall project progress. Moreover, the project management system 100 captures a timestamp of the actual installation time and date to update a project schedule with actual dates, forecast the completion date more accurately, report periodic progress to interested parties, track costs, manage the risk of delays in material installation for activities on a critical path, and generate periodic invoices from EPC contractors to owner operators or verify periodic invoices from contractors to owner operators.

In some implementations, the project planning module 102 is configured to generate an as-planned model of the project. The project planning module 102 generates, e.g., using Building Information Modeling (BIM), an 8D as-planned model of the project. The 8D model includes each material described in the engineering drawing of the project. Example materials include, but are not limited to, mechanical or electrical equipment, instruments, building materials, cables, and/or pipes. As described below, the project planning module 102 places the model on a map to assign planned GPS coordinates for each material. Thus, the 8D as-planned model is a GPS-enabled BIM.

FIG. 1B illustrates an example workflow 120 for generating an 8D as-planned BIM, according to some implementations. The workflow 120 can be performed by the project management system 100 of FIG. 1A. It will be understood that the workflow 120 can be performed, for example, by any suitable system, environment, software, hardware, or a combination of systems, environments, software, and hardware, as appropriate. In some implementations, various steps the workflow 120 can be run in parallel, in combination, in loops, or in any order.

Step 122 involves developing a 3D engineering drawing of the project. The 3D engineering drawing provides a 3D rendering of the project to be constructed. Among other details, the 3D engineering drawing includes the materials for the project. Example materials include, but are not limited to, mechanical or electrical equipment, instruments, building materials, cables, and/or pipes. Step 122 may involve using an artificial intelligence tool to generate the 3D engineering drawing. Additionally, or alternatively, this step may involve receiving user input providing information for generating the 3D engineering drawing.

Step 124 involves using engineering tools to auto-generate a project schedule from the 3D engineering drawing. In this step, each equipment, pipe, cable, or instrument in the 3D engineering drawing is linked to a schedule activity, thereby adding a 4^{th} dimension to the engineering drawing. The schedule can be determined using predefined schedule templates based on project type and subtype. Example project types include civil/infrastructure and onshore maintain potential projects, and example subtypes include water treatment plants and pipelines. In some examples, machine learning can be used to improve the templates based on user adjustments to the auto-generated schedule. For instance, scheduling engineers may adjust the schedule based on their knowledge and experience. A machine learning algorithm can be used to periodically analyze the trends of the schedule to continuously improve the predicted project schedule.

Step 126 involves using advance engineering tools to generate a material take-off (MTO), which is a list of required materials that need to be procured for the project. The MTO includes a unique identifier for each material, which can be obtained from corporate master data that includes a standard material catalog with a unique identifier for each material. This adds a 6^{th} dimension to the engineering drawing. In some examples, the generated MTO is provided as an input to a procurement system that can place purchase orders to vendors.

Step 128 involves using advance engineering tools to cost load the project schedule, for example, by obtaining the material prices from the corporate master library and calculating the average man-hours estimated to complete each task. This adds a 5^{th} dimension to the engineering drawing. This step can be performed using original manufacturers of the required materials in addition to the average man-hours required per each activity type and subtype. In some examples, machine learning can be used to improve the libraries by learning from historical data, such as user adjustments to the auto-generated cost.

Step 130 involves the procurement system placing each purchase order and identifying the purchase order number for each scheduled activity and/or for each material. Each purchase order will have a unique identifier and will generate an RFID tag to be printed by the vendor to tag the material for tracking purposes. The RFID is associated with the purchase order number and the material ID. The purchase order number adds a 7^{th} dimension to the engineering drawing.

Step 132 involves placing, using a GPS-enabled BIM, the engineering drawing on a map to generate the expected GPS coordinates for each equipment, pipe, cable or instrument in the engineering drawing. This adds an 8^{th} dimension to the engineering drawing.

Returning to FIG. 1A, as shown, the as-planned design is an 8D GPS-enabled BIM. The project planning module 102 analyzes the 8D BIM to generate the material take-off (MTO) required for the construct the facility. The project planning module 102 communicates with the master data module 104 to obtain data related to the procurement of the required materials. For example, the project planning module 102 obtains material identifiers and costs of the materials. Additionally, the project planning module 102 determines GPS coordinates for the materials in the project worksite and integrates the GPS coordinates into the project design.

Furthermore, the project planning module 102 generates a schedule for the project. In some examples, as shown in FIG. 1A, the schedule includes information such as start/end dates for the project, timelines and schedules for activities or tasks required for the project, rules of credit information, and/or dependency and critical path information. The rules of credit information is a standard library at the enterprise level that determines the progress percentage per step for a certain activity type, subtype, and discipline. As shown in FIG. A, the rules of credit information can be received from master data module 104. The critical path information specifies the sequence of activities that must be completed on time for a project to be finished by the deadline. The project planning module 102 can integrate the schedule in the project design. Accordingly, the project design can have up to eight dimensions of information: a 3D model, material identifiers, GPS coordinates, cost information, a purchase order, and a project schedule. The following are examples of rules of credit information:

| | |
|---|---|
| Example 1 | 1- Activity name: Building Concrete |
| | Foundation |
| | Activity type: Civil |
| | Activity Subtype: Buildings |
| | Step-1: Excavation |
| | Step-1 Progress: 5% |
| | Step-2: Lean Concrete |
| | Step-2 Progress: 5% |
| | Step-3: Formworks |
| | Step-3 Progress: 10% |
| | Step-4: Reinforcement Preparation |
| | Step-4 Progress: 15% |
| | Step-5: Concrete Casting |
| | Step-5 Progress: 30% |
| | Step-6: Remove Formwork |
| | Step-6 Progress: 10% |
| | Step-7: Backfilling |
| | Step-7 Progress: 10% |
| | Step-8: Final Check & QA/QC Certification |
| | Step-8 Progress: 15% |
| Example 2 | 1- Activity name: Demolition of |
| | Electrical Equipment/Devices/Units |
| | Activity type: Electrical Work |
| | Activity Subtype: Demolition |
| | Step-1: Disconnection |
| | Step-1 Progress: 20% |
| | Step-2: Demolition |
| | Step-2 Progress: 40% |
| | Step-3: Removal of Debris |
| | Step-3 Progress: 30% |
| | Step-4: Final Check & QA/QC Inspection |
| | Step-4 Progress: 10% |

In some implementations, the master data module 104 is configured to obtain rules of credit and procurement information. The master data module 104 is also configured to obtain procurement information for the materials used in the project. In particular, the master data module 104 obtains materials identifiers and obtains material specifications. Further, the master data module 104 generates RFID tag identifiers. The master data module 104 can also print the RFD tags for materials and facilitate for the RFID tags to be attached to their respective materials. In some examples, the RFID tags are active RFID tags that include embedded GPS receivers. The printing and/or attachment can occur at the point of manufacture or procurement. The master data module 104 can communicate with the project planning module 102 to provide it with the rules of credit and/or procurement information. As previously explained, the project planning module 102 can integrate that information into the project design.

As explained previously, the engineering drawing will generate a list of materials required to construct the project, which will be integrated with the procurement system to place the purchase orders (POs) and generate the RFID tags per each mechanical or electrical equipment, instrument, cable, and pipe on the drawing. These POs will be assigned as an additional dimension to the drawing on BIM.

In some implementations, the project procurement and construction module 106 is configured to procure the required materials for the project. For example, the project procurement and construction module 106 can place purchase orders for the required materials with approved vendors. Additionally, the project procurement and construction module 106 is configured to track the delivery of materials to the worksite. In some examples, the project procurement and construction module 106 uses an RFID solution for tracking material delivery at the worksite. More specifically, the project procurement and construction module 106 can include a network of active RFID readers in the worksite. The network of GPS-enabled RFID readers can determine the GPS coordinates of materials by reading the RFID tags attached to the materials.

In some implementations, the project procurement and construction module 106 uses the network of RFID readers to determine that a material has been delivered to the worksite. Additionally, the project procurement and construction module 106 can use the RFID readers to track the movement of the material in the worksite. In particular, the project procurement and construction module 106 can determine an installation status of the material by capturing the actual GPS coordinates (x-axis, y-axis, and z-axis) of the material in the worksite and comparing the actual GPS coordinates to the planned GPS coordinates. Once the planned and actual GPS coordinates match, the project procurement and construction module 106 can generate an alert for a responsible engineer or user to inspect the installation. Once the installation has been approved, the project procurement and construction module 106 captures the installation timestamp for periodic progress reporting and invoicing.

In some implementations, once the project or task is inspected and approved, the modeling module 108 generates or updates an as-built and real-time engineering model 112 by updating the as-planned model with the real-world data. The real-time model 112 can be accessed and reviewed by users. For example, a representation of the real-time model 112 can be displayed on a graphical user interface (GUI).

In some implementations, the decision-making and recommendation module 110 performs one or more actions 114 based on the as-built engineering model. In an example, the decision-making and recommendation module 110 can perform periodic progress reporting, update the project schedule with actual data to forecast project completion date, manage the risk of delays, generate invoices to owner-operators and/or verify periodic contractor or vendor invoices based on the progress.

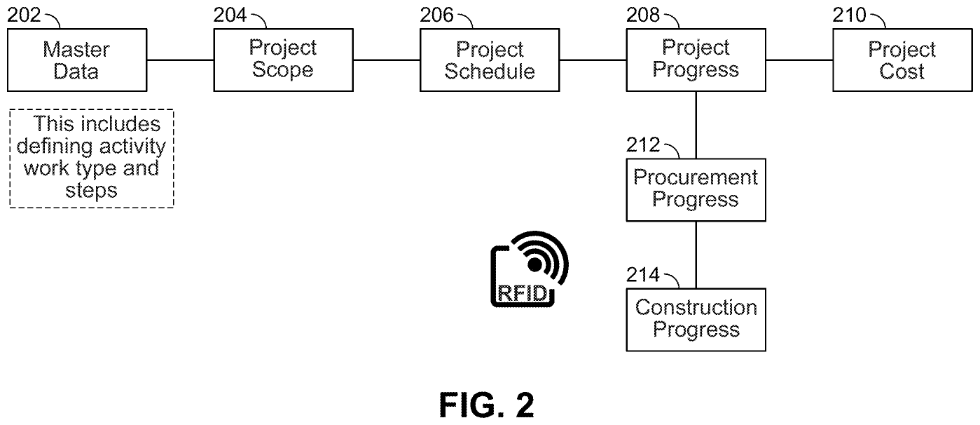

FIG. 2 illustrates a block diagram of example data 200 processed by a project management system, according to some implementations. As shown in FIG. 2, a project management system can integrate master data 202 (e.g., defining work activity type and the associated steps), project scope 204, project schedule 206, and project cost 210 to generate a planned project design. Then, the project management system can incorporate project process data 208 in order to generate an as-built model of the project. The project process data 208 includes procurement progress data 212 and construction progress data 214.

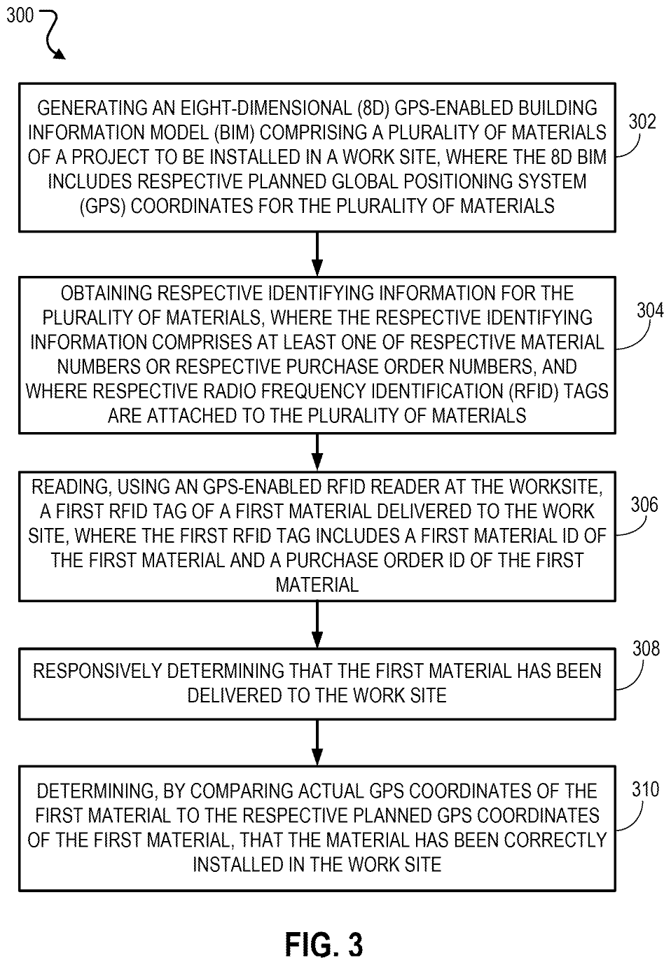

FIG. 3 illustrates a flowchart of an example method 300, according to some implementations. For clarity of presentation, the description that follows generally describes method 300 in the context of the other figures in this description. For example, method 300 can be performed by the project management system 100 of FIG. 1A. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

At step 302, method 300 involves generating an eight-dimensional (8D) GPS-enabled building information model (BIM) includes a plurality of materials of a project to be installed in a worksite, where the 8D BIM includes respective planned global positioning system (GPS) coordinates for the plurality of materials.

At step 304, method 300 involves obtaining respective identifying information for the plurality of materials, where the respective identifying information includes at least one of respective material numbers or respective purchase order numbers, and where respective radio frequency identification (RFID) tags are attached to the plurality of materials. Note that RFID code returns both the material ID and purchase order number when scanned. This is because the material ID is read from corporate master data and unique per material, but it can be repeated in multiple purchase orders. The purchase order is also a unique identifier, but can contain multiple materials.

At step 306, method 300 involves reading, using a GPS-enabled RFID reader at the worksite, a first RFID tag of a first material delivered to the worksite, where the first RFID tag includes a first material ID of the first material and a purchase order ID of the first material.

At step 308, method 300 involves responsively determining that the first material has been delivered to the worksite.

At step 310, method 300 involves determining, by comparing actual GPS coordinates of the first material to the respective planned GPS coordinates of the first material, that the material has been correctly installed in the worksite. The actual GPS coordinates are determined using the GPS-enabled RFID reader.

In some implementations, the method further involves printing the respective RFID tags for the plurality of materials; and attaching the respective RFID tags to the plurality of materials.

In some implementations, the RFID reader is integrated with a GPS device.

In some implementations, responsively determining that the first material has been delivered to the worksite further involves updating a procurement status for the first material to indicate that that first material has been delivered.

In some implementations, the method further involves in response to updating the procurement status for the first material to indicate that that first material has been delivered, generating an invoice or verifying a vendor invoice for the first material.

In some implementations, responsively determining that the first material has been delivered to the worksite further involves generating a timestamp at a time of delivery; and updating, based on the timestamp, a completion time for the project.

In some implementations, the method further involves using the timestamp for at least one of: periodic progress reporting that is indicative of a number of procurement activities that have been completed within a time period; or verifying periodic invoices for work that has been completed within a contractual time period. Depending on the contractual agreement, the invoices can be submitted on a monthly basis for the work performed during the month, on a quarterly basis, or based on milestone completion. The time stamp will help verify the periodic invoices based on contractual agreements with the vendors.

In some implementations, the method further involves generating an 8D model of the project.

In some implementations, the method further involves updating the 8D model of the project based on the actual GPS coordinates of the first material.

FIG. 4 is a block diagram of an example computer system 400 that can be used to provide computational functionalities associated with described algorithms, methods, functions, processes, flows, and procedures, according to some implementations of the present disclosure. In some implementations, the project management system 100 of FIG. 1 can be the computer system 400, include the computer system 400, or the project management system 100 can communicate with the computer system 400.

The illustrated computer 402 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 402 can include a Smart Embedded Management Agent (SEMA), such as a built-in ADLINK SEMA 2.2, and a video sync technology, such as Quick Sync Video technology supported by ADLINK MSDK+. In some examples, the computer 402 can include the MXE-5400 Series processor-based fanless embedded computer by ADLINK, though the computer 402 can take other forms or include other components.

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both), over the system bus. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs 412.

The service layer 413 can provide software services to the computer 402 and other components (whether illustrated or not) that are communicably coupled to the computer 402. The functionality of the computer 402 can be accessible for all service consumers using this service layer 413. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 can include an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and manipulate data to perform the operations of the computer 402, including operations using algorithms, methods, functions, processes, flows, and procedures as described in the present disclosure.

The computer 402 can also include a database 406 that can hold data for the computer 402 and other components connected to the network 430 (whether illustrated or not). For example, database 406 can be an in-memory, conventional, or a database storing data consistent with the present disclosure. In some implementations, the database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

An application 408 can be an algorithmic software engine providing functionality according to particular needs, desires, or particular implementations of the computer 402 and the described functionality. For example, an application 408 can serve as one or more components, modules, or applications 408. Multiple applications 408 can be implemented on the computer 402. Each application 408 can be internal or external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system including computer 402, with each computer 402 communicating over network 430. Further, the terms “client,” “user,” and other appropriate terminology can be used interchangeably without departing from the scope of the present disclosure. Moreover, the present disclosure contemplates that many users can use one computer 402 and one user can use multiple computers 402.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

As shown in FIG. 4, the computer 402 further includes corporate master data 426 stored in database 406. As previously described, the corporate master data 426 includes rules of credit, procurement information, and a material catalog (e.g., material ID, material name, material description, and material vendor). The computer 402 further includes a digital-twin platform 416 with GPS-enabled Building Information Model (BIM) 418. Further, the computer 402 includes an AI module 420 for auto-generating the project schedule from the engineering drawing, cost loading the schedule and linking each equipment, cable, instrument, or pipe on the drawing to an activity on the project schedule.

The computer 402 also includes project management information system (PMIS) 422 for decision making and recommendations based on comparing the as-planned model with data collected from worksite to update the as-built model with real data and calculating the periodic progress percentage. Further, the computer 402 includes corporate procurement system 424 that auto-generates RFID code per each PO and reference standard material catalog on a corporate level. As also shown in FIG. 4, the computing system 400 includes GPS-enabled RFID readers 428 installed in the worksite.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
generating an eight-dimensional (8D) GPS-enabled building information model (BIM) comprising a plurality of materials of a project to be installed in a worksite, wherein the 8D BIM includes respective planned global positioning system (GPS) coordinates for the plurality of materials;
obtaining respective identifying information for the plurality of materials, wherein the respective identifying information comprises at least one of respective material numbers or respective purchase order numbers, and wherein respective radio frequency identification (RFID) tags are attached to the plurality of materials;
reading, using a GPS-enabled RFID reader at the worksite, a first RFID tag of a first material delivered to the worksite, wherein the first RFID tag includes a first material ID of the first material and a purchase order ID of the first material;
responsively determining that the first material has been delivered to the worksite; and
determining, by comparing actual GPS coordinates of the first material to the respective planned GPS coordinates of the first material, that the material has been correctly installed in the worksite.

2. The method of claim 1, further comprising:
printing the respective RFID tags for the plurality of materials; and
attaching the respective RFID tags to the plurality of materials.

3. The method of claim 1, wherein the RFID reader is integrated with a GPS device.

4. The method of claim 1, wherein responsively determining that the first material has been delivered to the worksite further comprises updating a procurement status for the first material to indicate that that first material has been delivered.

5. The method of claim 4, further comprising:
in response to updating the procurement status for the first material to indicate that that first material has been delivered, generating an invoice or verifying a vendor invoice for the first material.

6. The method of claim 1, wherein responsively determining that the first material has been delivered to the worksite further comprises:
generating a timestamp at a time of delivery; and
updating, based on the timestamp, a completion time for the project.

7. The method of claim 6, further comprising using the timestamp for at least one of:
periodic progress reporting that is indicative of a number of procurement activities that have been completed within a time period; or
verifying periodic invoices for work that has been completed within a contractual time period.

8. The method of claim 1, further comprising generating an 8D model of the project.

9. The method of claim 8, further comprising updating the 8D model of the project based on the actual GPS coordinates of the first material.

10. A system comprising:
one or more processors configured to perform operations comprising:
generating an eight-dimensional (8D) GPS-enabled building information model (BIM) comprising a plurality of materials of a project to be installed in a worksite, wherein the 8D BIM includes respective planned global positioning system (GPS) coordinates for the plurality of materials;
obtaining respective identifying information for the plurality of materials, wherein the respective identifying information comprises at least one of respective material numbers or respective purchase order numbers, and wherein respective radio frequency identification (RFID) tags are attached to the plurality of materials;
reading, using a GPS-enabled RFID reader at the worksite, a first RFID tag of a first material delivered to the worksite, wherein the first RFID tag includes a first material ID of the first material and a purchase order ID of the first material;
responsively determining that the first material has been delivered to the worksite; and
determining, by comparing actual GPS coordinates of the first material to the respective planned GPS coordinates of the first material, that the material has been correctly installed in the worksite.

11. The system of claim 10, the operations further comprising:
providing instructions to a printing system to print the respective RFID tags for the plurality of materials; and
causing the respective RFID tags to be attached to the plurality of materials.

12. The system of claim 10, wherein the RFID reader is integrated with a GPS device.

13. The system of claim 10, wherein responsively determining that the first material has been delivered to the worksite further comprises updating a procurement status for the first material to indicate that that first material has been delivered.

14. The system of claim 13, the operations further comprising:
in response to updating the procurement status for the first material to indicate that that first material has been delivered, generating an invoice or verifying a vendor invoice for the first material.

15. The system of claim 10, wherein responsively determining that the first material has been delivered to the worksite further comprises:
generating a timestamp at a time of delivery; and
updating, based on the timestamp, a completion time for the project.

16. The system of claim 15, the operations further comprising using the timestamp for at least one of:
periodic progress reporting that is indicative of a number of procurement activities that have been completed within a time period; or
verifying periodic invoices for work that has been completed within a contractual time period.

17. The system of claim 10, the operations further comprising generating an 8D model of the project.

18. The system of claim 17, the operations further comprising updating the 8D model of the project based on the actual GPS coordinates of the first material.

19. A non-transitory computer storage medium encoded with instructions that, when executed by one or more computers, cause the one or more computers to perform operations comprising:
generating an eight-dimensional (8D) GPS-enabled building information model (BIM) comprising a plurality of materials of a project to be installed in a worksite, wherein the 8D BIM includes respective planned global positioning system (GPS) coordinates for the plurality of materials;
obtaining respective identifying information for the plurality of materials, wherein the respective identifying information comprises at least one of respective material numbers or respective purchase order numbers, and wherein respective radio frequency identification (RFID) tags are attached to the plurality of materials;
reading, using a GPS-enabled RFID reader at the worksite, a first RFID tag of a first material delivered to the worksite, wherein the first RFID tag includes a first material ID of the first material and a purchase order ID of the first material;
responsively determining that the first material has been delivered to the worksite; and
determining, by comparing actual GPS coordinates of the first material to the respective planned GPS coordinates of the first material, that the material has been correctly installed in the worksite.

20. The non-transitory computer storage medium of claim 19, the operations further comprising:
providing instructions to a printing system to print the respective RFID tags for the plurality of materials; and
causing the respective RFID tags to be attached to the plurality of materials.
